(19) United States
(12) Patent Application Publication
(10) Pub. No.: US 2005/0037205 A1
(43) Pub. Date: Feb. 17, 2005

(54) Composite skin for instrument panel and other parts of vehicle passenger compartment, method for makig same and composition used for preparing same and method for producing it

(76) Inventors: Anne Dalzotto, Reims (FR); Geoffroy Simonnet, Reims (FR); Dominique Beis, Prunay (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/478,472

(22) PCT Filed: May 21, 2002
(86) PCT No.: PCT/FR02/01702

(30) Foreign Application Priority Data
May 22, 2001 (FR) 01/06734
May 22, 2001 (FR) 01/06735

(51) Int. Cl. B32B 9/04

(52) U.S. Cl. 428/411.1

(57) ABSTRACT

The invention concerns a composite skin for part of a passenger compartment housing an incorporated airbag comprising a ductile layer and a fragile layer. Said skin is useful for instrument panels and/or door panels. The invention also concerns a method for preparing said inventive composite skin, by double slush moulding. The invention further concerns a composition useful for making a ductile layer and a method for preparing such a composition.

### TECHNICAL FIELD OF THE INVENTION

A subject of the invention is a new composite skin for parts of vehicle passenger compartments, intended more particularly to be equipped with integrated airbags (also called invisible airbags). The invention applies in particular to instrument panels and to door interiors (or door panels). A subject of the invention is also a process for producing this skin, more particularly by (double) slush moulding. Finally, a subject of the invention is also a composition used for preparing said skin.

### PRIOR ART AND TECHNICAL PROBLEM

Motor vehicle instrument panels are known. The skins of the latter are produced in standard manner by the moulding technique of pouring powder over a hot mould (a technique which comprises rotational moulding and slush moulding).

These instrument panels generally comprise an external “skin” (monolayer) which provides the external appearance. They then often receive integrated airbags, which in a standard fashion, have very short opening times. The instrument panel also has notches (inside). During the opening of the airbag, the skin of the instrument panel must not generate any projection of particles into the passenger compartment, in particular at low temperatures (−35° C.). At higher temperatures, for example 80° C., this skin must break rapidly without too much deformation, as such deformations can prevent deployment of the airbag. These problems are similarly encountered for parts of the passenger compartment into which airbags are inserted, for example the lateral struts, the rear faces of the front passenger seats, the doors etc. The problem is thus common to all parts of the passenger compartment receiving an integrated airbag (thus more or less invisible to the passengers and driver).

The standard skins are already made from plasticized PVC, therefore in order to improve behaviour at low temperatures, this level of plasticizer is increased. This results in problems of too much creep at 80° C. It also leads to more expensive formulae and lower productivity (longer cycles and fairly high level of production rejects),

In the production of parts for vehicles, notably land vehicles, there is also the problem of recycling, both for the production rejects and for waste originating from end-of-life vehicles (ELVs, in accordance with the European ELV directive of October 2000). This recycling problem is still more acute when recycling for the same use is desired, i.e. isofunctional recycling.

The invention makes it possible to resolve one or two of the problems identified above. According to one embodiment, the invention provides an overall solution enabling both isofunctional recycling and the sought behaviour for the skin from −35 to 80° C.

### SUMMARY OF THE INVENTION

The invention thus provides a composite skin for parts of passenger compartments housing integrated airbags, comprising a ductile layer and a brittle layer.

According to one embodiment, the ductile layer is the internal layer and the brittle layer is the external layer.

According to one embodiment, the ductile layer is the external layer and the brittle layer is the internal layer.

These parts can comprise instrument panels and/or door panels.

Typically, the brittle layer has a brittle rupture at −35° C., whilst the ductile layer has a ductile rupture at this temperature.

According to one embodiment, the ductile layer has a brittle temperature below −35° C., preferably between −60° C. and −40° C.

According to one embodiment, the brittle layer has a brittle temperature above −35° C., preferably between −30° C. and −20° C.

According to one embodiment, the ductile and/or brittle layer has a thickness comprised between 0.4 and 1.2 mm, preferably between 0.5 and 0.9 mm.

According to one embodiment, the ductile and/or brittle layer is based on thermoplastic polyolefin.

According to one embodiment, the ductile and/or brittle layer is based on plasticized PVC.

According to a variant of the invention, this ductile layer is based on a composition of plasticized PVC, another subject of the invention.

The invention therefore also provides a composition, in particular intended to be used as a ductile layer according to the invention, said composition comprising up to 98% by weight of plasticized PVC source and at least 2% by weight of at least one compatible polymer, having good cold properties, preferably up to 95% and 5% respectively.

According to one embodiment, the composition comprises, by weight:

from 50 to 98%, preferably from 70 to 90%, of plasticized PVC source, this plasticized PVC source having a recycled PVC/virgin PVC composition varying from 100/0 to 0/100; and

from 2 to 50%, preferably from 30 to 10%, of at least one compatible polymer.

According to one embodiment, the composition comprises from 70 to 98% by weight of recycled PVC and from 30% to 2% by weight of at least one compatible polymer having good cold properties.

According to one embodiment, the composition comprises from 10 to 50% by weight of recycled PVC, from 30 to 85% of virgin PVC and from 30% to 5% by weight of at least one compatible polymer having good cold properties.

According to one embodiment, the composition comprises, by weight:

30 to 40% of recycled PVC;

10 to 20% of at least one compatible polymer;

40 to 60% of virgin PVC, this virgin PVC containing PVC with a Kwert of 50 to 80, preferably 55 to 75, in combination with plasticizers, according to a PVC/plasticizer weight ratio of 70/30 to 40/60.

According to one embodiment, the polymer having good cold properties has a glass transition temperature Tg below −30° C., preferably below −40° C.

According to one embodiment, the polymer having good cold properties is an elastomer.

According to one embodiment, the polymer having good cold properties is chosen from:
(i) thermoplastic polyurethane;
(ii) thermoplastic polyetherester;
(iii) polyetherblockamide;
(iv) ethylene/vinyl monomer polymer, functionalized or non-functionalized.
(v) ethylene/alkyl (meth)acrylate or (meth)acrylic acid polymer, functionalized or non-functionalized;
(vi) ethylene/vinyl monomer/alkyl (meth)acrylate terpolymer, functionalized or non-functionalized;
(vii) ethylene/vinyl monomer/carbonyl terpolymer;
(viii) ethylene/alkyl(meth)acrylate/carbonyl terpolymer;
(ix) core-shell type MBS polymer;
(x) SBM block terpolymers
(xi) chlorinated or chlorosulphonated polyethylene;
(xii) PVDF;
(xiii) elastomer processable in the molten state.

The invention also provides a vehicle comprising a passenger compartment part according to the invention.

A subject of the invention is also a process for preparing a skin for part of a passenger compartment according to the invention, by double slush moulding.

A subject of the invention is also a process for preparing a composition according to the invention.

### BRIEF DESCRIPTION OF THE FIGURES

The invention is now described in more detail in the following description and with reference to the attached drawings, in which:

FIG. 1 represents a cross-section of the skin according to the invention.

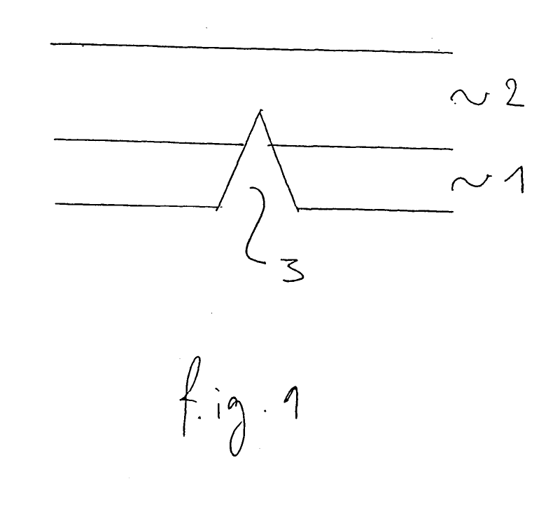

### DETAILED DESCRIPTION OF THE INVENTION

The invention is based on the principle of the ductile rupture/brittle rupture duality. It is recalled that brittle rupture is a rupture following slight deformation and with considerable fragmentation, whereas ductile rupture is a rupture following considerable deformation and without fragmentation. The brittleness is measured by the brittle temperature, in accordance with the standard ASTM D746.

In the figure, the skin comprises a ductile internal layer (1) and a brittle external layer (2). The external layer is that situated on the passenger compartment side of the vehicle. A notch (3) or pre-cut-out is generally present; this notch generally reaches the brittle layer.

The function of the skin is as follows:

at low temperatures (typically −35° C.), during the explosion of the airbag, the brittle layer will break and remain “stuck” to the ductile layer which is still flexible and deformable. Generally, the deeper the cut-out, the less energy is required to break the brittle skin. In this case, there is generally less risk of the two layers becoming separated. These layers are capable of being adapted in composition in order that the rupture will be either a cohesive or adhesive rupture; and

at high temperatures (typically 80° C.), only the external layer is concerned, which poses no problem, this layer behaving in a standard fashion, namely immediate rupture thus avoiding deformation of the skin (and thus defective deployment of the airbag).

According to another embodiment, the brittle and ductile layers are reversed. The pre-cut-out can be absent or present, in one of the layers only or optionally in both (partially in one).

Brittle Layer

This brittle layer corresponds approximately to the standard skin currently used. Typically, the brittle temperature, as measured in accordance with the standard ASTM D746, is above −35° C., in a standard fashion between −30° C. and −20° C.

This layer comprises a polymer adapted to be used as a skin. Polyolefin thermoplastics (for example fluid polypropylene with elastomer additives), as well as cross-linkable polyolefins (for example silane-grafted polyethylene) can be mentioned. Thermoplastic polyurethane and plasticized PVC can also be mentioned.

The PVC capable of being used is standard; it can be produced in particular as a solid, in suspension or in emulsion. Its Kwert value (hereafter called Kw) is generally comprised between 50 and 80, preferably between 55 and 75.

The PVC is also mixed, in a standard fashion, with plasticizers, such as trimellitate, and alcohol phthalates, typically of C8 to C13, in particular C8 to C11. Their quantity varies as a function of the final hardness sought, surface qualities, the PVC's Kwert, etc. It is possible to use, for example, from 30 to 60% by weight of plasticizer.

The other additives capable of being used in this layer are described in the literature, such as for example in the document FR-A-2746807.

This brittle layer can be hardened (Shore A hardness), with respect to the compositions for standard monolayer skins, in order to improve abrasion and scratch resistance. It is also possible to reduce the Kwert of the base resin, in order to optimize the production time of the skins.

Ductile Layer

This layer plays the role of adhesive at low temperatures: typically it has a ductile rupture at −35° C. in order to maintain the fragments generated during brittle rupture of the brittle layer. Preferably, it can contain recycled PVC. At a high temperature, it is highly fluidized, which no longer interferes with the rupture of the brittle layer. Typically, the brittle temperature, as measured in accordance with the standard ASTM D746, is below −35° C., as standard between −60° C. and −40° C.

This ductile layer can comprise an adhesive layer, for example glue, varnish, or hot-melt having cold properties.

This ductile layer can also be based on the same polymer as that forming the brittle layer.

By way of example, the ductile layer can comprise PVC and plasticizers, the latter being present in quantities greater than those used for the brittle layer.

According to a preferred embodiment, the ductile layer comprises recycled PVC, which can originate from the recycling of instrument panels and other parts for passenger compartments etc. This term “PVC from recycling” refers to waste with a PVC-based composition, used for the production of instrument panels and other passenger compartment parts, such as door panels. The standard additives are present therein, as well as the plasticizers. It is similar to the term “recycled PVC”.

The ductile layer can also comprise virgin PVC only (this virgin PVC being able to contain a significant proportion of plasticizer).

The ductile layer can also contain both recycled and virgin PVC.

In combination with this PVC, a compound is used which makes it possible to obtain cold properties. This compound can be the standard plasticizer, used in larger quantities (than in the brittle layer) in order to confer the properties at −35° C.

In combination with this PVC, at least one “related” polymer, which is compatible and has good cold properties, capable of conferring an appropriate brittleness, is used. This related polymer advantageously has a glass transition temperature Tg below −30° C., preferably below −40° C.

The ductile layer can thus comprise, by weight:

from 50 to 98% of plasticized PVC source, preferably from 70 to 90%, this PVC source having a recycled PVC/virgin PVC composition which can vary from 100/0 to 0/100.

from 2 to 50% of at least one related polymer (compatible polymer having good cold properties), preferably 30 to 10%.

A typical ductile layer formulation is as follows:

30 to 40% of recycled PVC;

10 to 20% of related polymer;

40 to 60% of virgin PVC, this virgin PVC containing PVC with a Kwert of 55 to 80, preferably 55 to 75, in combination with plasticizers, according to a PVC/plasticizer weight ratio of 70/30 to 40/60.

A number of related polymers can be used. By way of example, elastomers can be used, in particular thermoplastics.

As related polymers, the following polymers can be mentioned:
(i) thermoplastic polyurethane;
(ii) thermoplastic polyetherester;
(iii) polyetherblockamide;
(iv) ethylene/vinyl monomer polymer, functionalized or non-functionalized.
(v) ethylene/alkyl (meth)acrylate or (meth)acrylic acid polymer, functionalized or non-functionalized;
(vi) ethylene/vinyl monomer/alkyl(meth)acrylate terpolymer/, functionalized or non-functionalized;
(vii) ethylene/vinyl monomer/carbonyl terpolymer;
(viii) ethylene/alkyl (meth)acrylate/carbonyl terpolymer;
(ix) core-shell type MBS polymer;
(x) SBM block terpolymers
(xi) chlorinated or chlorosulphonated polyethylene;
(xii) PVDF;
(xiii) elastomer processable in the molten state.

The thermoplastic polyurethane (i) can in particular contain sequences or blocks which are flexible segments. By this term “flexible segment”, is meant for example polyether or polyesterdiol blocks.

The following TPUs can be mentioned:

polyurethaneether, for example comprising polyether sequences having hydroxy ends, linked to diisocyanates by urethane functions;

polyurethaneester, for example comprising polyester sequences having hydroxy ends, linked to diisocyanates by urethane functions;

polyurethaneetherester, for example comprising polyester sequences and polyether sequences having hydroxy ends, these sequences being linked to diisocyanate residues by urethane functions. It is also possible to have polyetherpolyester chains having hydroxy ends linked to diisocyanates by urethane functions.

An example of TPU is Goodrich's Estane®, as well as BASF's Elastollan® and Bayer's Desmopan®.

The thermoplastic polyetherester (ii) can for example comprise polyether sequences having hydroxy ends, linked to polyester sequences with acid ends, this structure also being able to comprise diols (for example 1,4-butanediol).

An example of such a polyetherester is Dupont's Hytrel®.

The polyetherblockamide (iii) is a polyamide block and polyether block copolymer.

These copolyamide block and polyether block polymers result from the copolycondensation of polyamide sequences having reactive ends with polyether sequences having reactive ends, such as, inter alia:

(1) Polyamide sequences having diamine chain ends with polyoxyalkylene sequences having dicarboxylic chain ends;

(2) Polyamide sequences having dicarboxylic chain ends with polyoxyalkylene sequences having diamine chain ends obtained by cyanoethylation and hydrogenation of aliphatic dihydroxylated alpha-omega polyoxyalkylene sequences called polyetherdiols;

(3) Polyamide sequences with dicarboxylic chain ends with polyetherdiols, the products obtained being, in this particular case, polyetheresteramides.

The polyamide sequences having dicarboxylic chain ends originate for example from the condensation of polyamide precursors in the presence of a chain-limiting carboxylic diacid.

The polyamide sequences having diamine chain ends originate for example from the condensation of polyamide precursors in the presence of a chain-limiting diamine.

The polyamide block and polyether block polymers can also comprise units distributed in a random fashion.

An example of such a polyetheramide is Atofina's Pebax® as well as Hüls's PEBA Vestamid®.

The copolymer (iv) is based on ethylene and a vinyl monomer of the vinyl acetate family, this monomer generally representing from 5 to 40% by weight of the copolymer.

The copolymer (v) is based on ethylene and alkyl (meth)acrylate which generally represents from 5 to 40% by weight of the copolymer.

The alkyl (meth)acrylate monomer can have up to 24 and preferably 10 carbon atoms and can be linear, branched or cyclic. By way of illustration of the alkyl (meth)acrylate, n-butyl acrylate, isobutyl acrylate, ethyl-2-hexyl acrylate, cyclohexyl acrylate, methyl methacrylate, ethyl methacrylate can in particular be mentioned. Among these (meth)acrylates, ethyl acrylate, n-butyl acrylate and methyl methacrylate are preferred.

Alternatively, it is based on ethylene and (meth)acrylic acid which generally represents up to 10% by moles. The acid functions can be wholly or partially neutralized by a cation (in particular metallic).

The copolymer (vi) is based on ethylene and the two comonomers described above, the latter being present in the same general proportions.

The information given with respect to the polymers (iv) and (v) apply here mutatis mutandis.

The polymers (iv), (v) and (vi) can optionally be functionalized. As examples of functions, the anhydrides, epoxides, isocyanates, isoxazones etc. can be mentioned.

Unsaturated carboxylic acid anhydride can be chosen for example from the maleic, itaconic, citraconic, allylsuccinic anhydrides etc.

As examples of unsaturated epoxides, the following can be mentioned:

the aliphatic glycidyl esters and ethers such as allyl glycidyl ether, vinyl glycidyl ether, glycidyl maleate and itaconate, glycidyl (meth)acrylate and

the alicyclic glycidyl esters and ethers.

These functionalities can be provided by grafting, or co- or ter-polymerization, according to known processes.

The terpolymer (vi) is based on ethylene and vinyl monomer, as above for (iv), and on a termonomer which is the carbonyl group. The same information as for the polymer (iv) applies here. An example is the terpolymer E/VA/CO. These polymers are in particular sold by Dupont under the Elvaloy® trademark.

The terpolymer (vii) is based on ethylene and alkyl (meth)acrylate, vinyl monomer, as above for (v), and a termonomer which is the carbonyl group. The same information as for the polymer (v) applies here. An example is the terpolymer E/nBA/CO. These polymers are in particular sold by Dupont under the Elvaloy® trademark.

Examples of such polymers (iv), (v) and (vi), functionalized or non-functionalized, are the following products: DuPont's Elvaloy®, and Atofina's Lotryl®, Lotader®, Evatane® and Orevac®.

The MBS-type polymer (ix) is a polymer with a standard “core-shell” structure, used as a impact modifier. It is obtained, in a standard fashion, by polymerization of the acrylic monomer on a suspension or latex of a butadiene/styrene copolymer. These products are known; an example is Atofina's product Metablend®.

Generally, all the PVC impact modifiers having good cold properties are also capable of being used in the invention.

The SBM (x) block terpolymer contains a first acrylic-type block, a second diene-type block, and a third styrene-type block, these blocks being obtained in particular by anionic synthesis (on a first monomer which is styrenic, then with a diene block, in order to finish with an acrylic block.

The first block is advantageously chosen from the homo- and copolymers of alkyl (meth)acrylate and for example of methyl methacrylate (PMMA) and/or of methyl or ethyl acrylate and optionally vinyl acetate.

The second block is advantageously a poly(diene), in particular poly(butadiene) (PB), poly(isoprene) and their partially or totally hydrogenated random copolymers.

The third block C is advantageously chosen from the homopolymers or styrene copolymers (PS) or α-methylstyrene.

Preferably, the SBM triblock is a PMMA/PB/PS, with proportions of, for example 30-50/30-50/20-40, and/or a molecular mass Mn for the PS of 20,000 to 50,000. This preferred SBM is used in the examples.

The chlorinated or chlorosulphonated polyethylene (xi) is standard.

An example of these chlorinated or chlorosulphonated polyethylenes is DuPont's Tyring® and DuPont-Dow's Hypalon® respectively.

The polyvinylidenedifluoride PVDF (xii) is also highly standard. Copolymers are also possible, with other (per)fluorinated monomers.

The elastomer which is processable in the molten state (xiii), also referred to as Melt Processable Rubber, is for example APA's product Alcryn®.

Mixtures are also possible, between polymers of the same nature or of different natures.

The same additives as described with respect to the brittle layer can be used in this ductile layer, if necessary. As regards the plasticizers, more or less can be added than in the brittle layer. Phthalate can be used on its own. Vinyl acetate/vinyl chloride copolymer type viscosity modifiers will optionally be used, in order to increase the gelation rate. Such a copolymer also promotes adhesion between the layers.

The ductile layer can be expandable, if desired. PMMA type processability additives can be added in order to regulate cell formation.

This ductile layer moreover has the advantage that its composition is simplified, as the colouring agents and UV stabilizers, as well as the release agent in particular are superfluous.

This layer can, if appropriate, be stabilized with Ca/Zn (thus “ordinary”) stabilizers and/or be enriched with anti-amine in order to serve as a barrier for the brittle layer.

The level of recycling can vary very widely (the level of related polymer is easily adapted), which confers very great flexibility. On the other hand, the presence in the composition of the ductile layer of support type impurities (PP, ABS, PC, etc.) presents no problem, as imperfections are acceptable in the sub-layer (being invisible).

PVC Composition According to the Invention

A subject of the invention is also the PVC composition which is used for production of the ductile layer. This composition, which allows recycling, in particular isofunctional recycling of the PVC, can be used in applications other than the parts of passenger compartments housing an integrated airbag.

The characteristics described above in the “ductile layer” section apply to the composition mutatis mutandis.

Production Process

The production process is preferably the “double slush moulding” process. This process is generally known, and is only differentiated from the standard “slush moulding” process by the addition of an additional powder container.

The external layer is moulded first, in a standard fashion, then the powder of the internal layer is introduced. In order to optimize the process, the fineness of the powder and the final MFI can be adjusted, in order to obtain a composition which gels rapidly (in order in particular to reduce the cycle times). In particular, ductile layer compositions having high MFIs (210° C., 2.16 kg), for example above 40 g/10 minutes, in particular above 60 g/10 minutes are preferred. It will also be possible, as indicated above, to incorporate additives provided for this purpose.

The production of powder is standard; cryogenic grinding (optionally proceeded by a granulation stage) and the microgranulation technique (so-called Gala® process) can be mentioned.

The powder dimensions are for example D50<1 mm, for example D50<700 μm, preferably D50<500 μm and advantageously a D50 of approximately 300 μm.

The implementation temperatures are also standard, as a function of the material retained in order to form the layers.

Other standard production processes can also be used.

As regards the introduction of the related polymer into the virgin or recycled PVC, this is done in a standard fashion, either in the form of powder, or at the extruder level, or at the (granule) storage hopper level. In the case of recycled PVC, extruder granulation is preferably used.

In preferred, but non-limitative fashion, the process comprises the following stages. For the brittle layer, starting with PVC in a powder, and the plasticizers and stabilizers are added into the mixer until a dry powder (“dry-blend”) is obtained. This dry powder is then moulded in order to form the brittle layer. For the ductile layer, a granulation phase is carried out in the first instance, during which the recycled PVC, related polymers and other components (virgin PVC and/or additives) are mixed. Granules are obtained which are then micronized, in particular by cryogenic grinding (the Gala technique also being possible, however). This powder is then moulded on the brittle layer in order to form the ductile layer.

### EXAMPLES

The following examples illustrate the example without limiting it.

### Example 1

The following PVC composition (Kw approximately 70) is prepared (in parts by weight):

PVC suspension (Kwert 70) 99.6

PVC emulsion (Kwert 64) 12.0

Epoxidized soya oil⁽¹⁾ 6.0

Trimellitate 75.0

Additives⁽²⁾ 7.5

⁽¹⁾: liquid co-stabilizer

⁽²⁾: stabilizers, colouring agents, etc.

This composition is a standard instrument panel skin composition. Its brittleness is approximately −22° C.

Instrument panel skins are prepared with this composition, by the slush-moulding process. The skins of these instrument panels are then separated from these. Their characteristics are tested; they do not fulfill the specifications at low temperatures. The skins of these instrument panels are then ground. The homogenates are used in the following examples.

### Example 2

The compositions according to Table 1 below are prepared. The cold properties (as measured according to the standard ASTM D-746) are indicated, as well as the MFI values.

TABLE 1

| | | | | | |
|---|---|---|---|---|---|
| Homogenates Ex. 1 | 100 | 80 | 80 | 80 | 80 |
| Hytrel | — | 20 | — | — | — |
| Estane | — | — | 20 | — | — |
| Pebax | — | — | — | 20 | — |
| SBM | — | — | — | — | 20 |
| Brittleness | −22° C. | −50° C. | −45° C. | −57° C. | −54° C. |
| MFI (210° C., 2.16 kg) | 60 | 70 | 120 | 100 | 80 |
| g/10 min | | | | | |

### Example 3

The compositions according to Table 2 below are prepared. The cold properties are indicated, as well as the MFI and hardness values.

TABLE 2

| | | | | |
|---|---|---|---|---|
| Homogenates Ex. 1 | 30 | 30 | 30 | 30 |
| TPU | 20 | — | — | — |
| Hytrel | — | 15 | — | — |
| Pebax | — | — | 15 | — |
| SBM | — | — | — | 15 |
| PVC suspension(1) | 26 | — | — | — |
| PVC solid(2) | — | 22 | 22 | 22 |
| Trimellitate | 24 | 28 | 28 | 32 |
| Stabilizer | 1 | 1 | 1 | 2 |
| VC/VA(3) | — | 4 | 4 | 4 |
| Brittleness | −46° C. | −46° C. | −50° C. | −54° C. |
| Hardness | 66A | 63A | 65A | 71A |
| MFI (210° C., 2.16 kg) g/10 min | 129 | 90 | 162 | — |
| MFI (190° C., 2.16 kg) g/10 min | — | — | — | 37 |

(1)Kwert 70
(2)Kwert 64
(3)Vinyl chloride and vinyl acetate (15%) copolymer.

### Example 4

The compositions according to Table 3 below are prepared. The cold properties are indicated, as well as the MFI, hardness and density values.

TABLE 3

| | | | | | | |
|---|---|---|---|---|---|---|
| Homogenates | 100 | 35 | 35 | 35 | 30 | 35 |
| Ex. 1 | | | | | | |
| TPU | — | 15 | — | — | — | — |
| Hytrel | — | — | 15 | 15 | 20 | — |
| Elvaloy(4) | — | — | — | — | — | 15- |
| PVC | — | 26 | — | — | — | — |
| suspension(1) | | | | | | |
| PVC solid(2) | — | — | 26 | 20 | 26 | 26 |
| Trimellitate | — | 12 | 12 | 12 | 12 | 7 |
| Phthalate | — | 12 | 12 | 12 | 12 | 7 |
| Stearic acid | — | 0.5 | 0.5 | 0.5 | 0.5 | 0.5 |
| VC/VA(3) | — | — | — | 6 | — | — |
| Brittleness | −22° C. | −45° C. | −50° C. | −47° C. | −57° C. | −53° C. |
| Hardness | 71A | 68A | 70A | 69A | 68A | 65A |
| MFI (210° C., | 61 | 120 | 73 | 115 | 71 | 52 |
| 2.16 kg).g/10 | | | | | | |
| min | | | | | | |
| Density | 1.21 | 1.18- | 1.18 | 1.17 | 1.15 | 1.16 |

(1)Kwert 70
(2)Kwert 64
(3)Vinyl chloride and vinyl acetate (15%) copolymer.
(4)E/nBA/CO type terpolymer.

### Example 5

Instrument panel skin composites are prepared by double slush moulding: the brittle skin is based on a standard formulation, according to Example 1, whereas the ductile layer is based on a composition according to the invention. The powder of the ductile layer is prepared by cryogenic grinding, to a particle dimension of 300-350 μm, with a maximum value of 500 μm. In the first instance double slush moulding is carried out by moulding of the brittle external layer then of the ductile internal layer. The temperature conditions are standard, in particular from 240° C. to 270° C., and the cycle times are for example from 1 to 2 minutes.

A ductile layer with a thickness of 0.7-0.8 mm is obtained, and a brittle layer with a thickness of 0.6-0.7 mm. These instrument panels obtained with this composite skin fulfill the temperature criteria over the −35° C. to 80° C. range.

1. Composite skin for part of a passenger compartment housing an integrated airbag comprising a ductile layer and a brittle layer, in which the ductile layer comprises up to 98% by weight of PVC source, and at least 2% by weight of at least one compatible polymer having good cold properties.

2. Skin according to claim 1, in which the ductile layer is the internal layer and the brittle layer is the external layer.

3. Skin according to claim 1, in which the ductile layer is the external layer and the brittle layer is the internal layer.

4. Skin according to claim 1, in which the ductile layer has a brittle temperature below −35° C., preferably between −60° C. and −40° C.

5. Skin according to claim 1, in which the brittle layer has a brittle temperature above −35° C., preferably between −30° C. and −20° C.

6. Skin according to claim 1, in which the ductile and/or brittle layer is based on plasticized PVC.

7. Skin according to claim 1, in which the ductile layer comprises, by weight,
from 50 to 98%, preferably from 70 to 90%, of PVC source, this PVC source having a recycled PVC/virgin PVC composition from 100/0 to 0/100; and
from 2 to 50%, preferably from 30 to 10%, of at least one compatible polymer.

8. Skin according to claim 1, in which the ductile layer comprises from 70 to 98% by weight of recycled PVC and from 30% to 2% by weight of at least one compatible polymer having good cold properties.

9. Skin according to claim 1, in which the ductile layer comprises from 10 to 50% by weight of recycled PVC, from 30 to 85% of virgin PVC and from 30% to 5% by weight of at least one compatible polymer having good cold properties.

10. Skin according to claim 1, in which the ductile layer comprises:—30 to 40% of recycled PVC;
10 to 20% of at least one compatible polymer;
40 to 60% of virgin PVC, this virgin PVC containing PVC with a Kwert of 50 to 80, preferably 55 to 75, in combination with plasticizers, according to a PVC/plasticizer weight ratio of 70/30 to 40/60.

11. Skin according to claim 1, in which the polymer having good cold properties has a glass transition temperature Tg below −30° C., preferably below −40° C.

12. Skin according to claim 1, in which the polymer having good cold properties is an elastomer.

13. Skin according to claim 1, in which the polymer having good cold properties is chosen from:
(i) thermoplastic polyurethane;
(ii) thermoplastic polyetherester;
(iii) polyetherblockamide;
(iv) ethylene/vinyl monomer polymer, functionalized or non-functionalized.
(v) ethylene/alkyl (meth)acrylate or (meth)acrylic acid polymer, functionalized or non-functionalized;
(vi) ethylene/vinyl monomer/alkyl (meth)acrylate terpolymer, functionalized or non-functionalized;
(vii) ethylene/vinyl monomer/carbonyl terpolymer;
(viii) ethylene/alkyl (meth)acrylate/carbonyl terpolymer;
(ix) core-shell type MBS polymer;
(x) SBM block terpolymers
(xi) chlorinated or chlorosulphonated polyethylene;
(xii) PVDF;
(xiii) elastomer processable in the molten state.

14. Skin according to claim 1, in which the brittle layer is based on thermoplastic polyolefin.

15. Skin according to claim 1, in which the ductile and/or brittle layer has a thickness comprised between 0.4 and 1.2 mm, preferably between 0.5 and 0.9 mm.

16. Part of passenger compartment comprising a skin according to claim 1.

17. Part of passenger compartment according to claim 16, which is chosen from instrument panels and/or door panels.

18. Vehicle comprising a part according to claim 16,

19. Process for the preparation of a skin according to claim 1, by double slush moulding.

20. Plasticized PVC composition comprising up to 98% by weight of plasticized PVC source and at least 2% by weight of at least one compatible polymer having good cold properties, the plasticized PVC source comprising recycled PVC or both recycled and virgin PVC, with a PVC composition of recycled/virgin PVC varying from 100/0 to 0/100.

21. Composition according to claim 20, comprising, by weight:
from 50 to 98%, preferably from 70 to 90%, of a plasticized PVC source; and
from 2 to 50%, preferably from 30 to 10%, of at least one compatible polymer.

22. Composition according to claim 20, comprising from 70 to 98% by weight of recycled PVC and from 30% to 2% by weight of at least one compatible polymer having good cold properties.

23. Composition according to claim 20, comprising from 10 to 50% by weight of recycled PVC, from 30 to 85% of virgin PVC and from 30% to 5% by weight of at least one compatible polymer having good cold properties.

24. Composition according to claim 20, comprising
30 to 40% of recycled PVC;
10 to 20% of at least one compatible polymer;
40 to 60% of virgin PVC, this virgin PVC containing PVC with a Kwert of 55 to 80, preferably 55 to 75, in combination with plasticizers, according to a PVC/plasticizer weight ratio of 70/30 to 40/60.

25. Composition according to claim 20, in which the polymer having good cold properties has a glass transition temperature Tg below −30° C., preferably below −40° C.

26. Composition according to claim 20, in which the polymer having good cold properties is an elastomer.

27. Composition according to claim 20, in which the polymer having good cold properties is chosen from:
(i) thermoplastic polyurethane;
(ii) thermoplastic polyetherester;
(iii) polyetherblockamide;
(iv) ethylene polymer/vinyl monomer, functionalized or non-functionalized.
(v) ethylene/alkyl (meth)acrylate or (meth)acrylic acid polymer, functionalized or non-functionalized;
(vi) ethylene/vinyl monomer/alkyl (meth)acrylate terpolymer, functionalized or non-functionalized;
(vii) ethylene/vinyl monomer/carbonyl terpolymer;
(viii) ethylene/alkyl (meth)acrylate/carbonyl terpolymer;
(ix) core-shell type MBS polymer;
(x) SBM block terpolymers
(xi) chlorinated or chlorosulphonated polyethylene;
(xii) PVDF;
(xiii) elastomer processable in the molten state.

28. Process for the preparation of a composition according to claim 20, in which the PVC source is mixed with said at least one compatible polymer.

29. Process according to claim 28, comprising the stage of supplying recycled PVC, by isofunctional recycling.
